(19) United States
(12) Patent Application Publication
(10) Pub. No.: US 2026/0262648 A1
(43) Pub. Date: Sep. 10, 2026

(54) Method of protecting citrus trees against disease caused by ACP infestation

(71) Applicant: VESTERGAARD SÀRL, Lausanne (CH)

(72) Inventors: Mikkel Vestergaard Frandsen, Lausanne (CH); Allan Mortensen, Lausanne (CH); Amar Ali, Lausanne (CH); Domenico Zocco, Lausanne (CH)

(73) Assignee: VESTERGAARD SÀRL, Lausanne (CH)

(21) Appl. No.: 19/555,026

(22) Filed: Mar. 3, 2026

Related U.S. Application Data
(60) Provisional application No. 63/767,792, filed on Mar. 6, 2025.

(51) Int. Cl. A01N 53/00; A01N 25/10; A01N 25/34; A01N 27/00; A01N 37/10; A01N 43/56; A01N 65/26; A01N 65/28; A01N 65/36; A01N 65/44; A01P 7/04

(52) U.S. Cl. CPC A01N 53/00; A01N 25/10; A01N 25/34; A01N 27/00; A01N 37/10; A01N 43/56; A01N 65/26; A01N 65/28; A01N 65/36; A01N 65/44; A01P 7/04

(57) ABSTRACT

In a plantation, such as a fruit farm, ACP are pushed away from adult trees by chemical repellents and pulled towards young trees by insect attractants, disposed on protective mesh material that also carries insecticide, which kills the insects upon contact. Due to this push-pull effect, not only the covered young trees are protected but also the adult trees.

### FIELD OF THE INVENTION

The present invention relates to protection of young and adult citrus trees against Huanglongbing (HLB) or yellow dragon disease, caused by Liberibacter spread by the Asian citrus psyllid (ACP), Diaphorina citri.

### BACKGROUND OF THE INVENTION

As discussed in U.S. Pat. No. 11,122,752, citrus greening is a serious citrus plant disease caused by bacteria (Liberibacter asiaticus) spread by the Asian citrus psyllid (ACP), Diaphorina citri. The disease, also called Huanglongbing (HLB) or yellow dragon disease, is a risk for the future of citrus farms in the US and other countries. Fruits from infected trees become bitter, and infected trees tend to die within a few years. Especially, due to attraction of psyllids to the new flush young trees, young trees are at greater risk of infection than mature trees. Accordingly, young trees need to be protected for several years from psyllids and leaf miners. As a countermeasure for protection of citrus trees, U.S. Pat. No. 11,122,752 recommends tree covers to enclose individual trees.

U.S. Pat. No. 10,143,197 discloses green-colored traps with insect attractants in the trees in order to lure ACP into the traps.

Chow et al. disclosed an alternative method in the article of “Development and Field Validation of a Beta-cyfluthrin-Based ‘Attract-and-Kill’ Device for Suppression of Asian Citrus Psyllid (Hemiptera: Liviidae) on Residential Citrus” published 2019 in Journal of Economic Entomology, XX(XX), 2019, 1-9 [doi: 10.1093/jee/toz221]. As reported in this article, green insecticidal attract-and-kill devices were tested in greenhouse conditions.

Mangan et al. suggested the use of light against ACP, as reported in the article “Evaluation of the effect of light source and plant materials on Asian citrus psyllid (Hemiptera: Psyllidae) trapping levels in the transtrap for citrus shipping containers”, published in Florida Entomologist 96(1) in March 2013.

George et al. investigated ACP suppression by UV reflective traps, as reported in the article “UV reflective properties of magnesium oxide increase attraction and probing behavior of Asian citrus psyllids (Hemiptera: Liviidae)” published in Nature Scientific Reports (2020) 10:1890[doi.org/10.1038/s 41598-020-58593-4.]

Martini et al. in reported a further approach in “Progress Toward an Attract-and-Kill Device for Asian Citrus Psyllid (Hemiptera: Liviidae) Using Volatile Signatures of Citrus Infected with Huanglongbing as the Attractant” published in Journal of Insect Science, (2020) 20(6): 25; 1-10 [doi: 10.1093/jisesa/ieaa126]-

As it appears from the above, there are several attempts for protecting citrus trees against ACP, but no consensus has yet been found a to the best methods for protection. Research is still ongoing, and there is still room for further improvements.

### DESCRIPTION/SUMMARY OF THE INVENTION

It is therefore an objective of the invention to provide an improvement in the art. In particular, it is an objective to provide a method for minimizing, if not preventing, harm to citrus trees by ACP. This objective and further advantages are achieved with a method as described in the following.

In short, the method presented herein relies on a push-pull effect in which the ACP are pushed away from adult citrus trees by chemical repellents and pulled towards young citrus trees by insect attractants on protective net covers that also contains insecticide, which kills the ACP upon contact. Due to this push-pull effect, not only the covered young trees are protected but also the adult trees. Although, the prior art focuses primarily on young trees, due to the higher risk for damage, it must be emphasized that also adult trees are at risk and should be included in the protective measures.

In more detail, a method is provided for protecting a plurality of young and adult citrus trees in a tree plantation against infestation by insects that are Asian citrus psyllids, ACP, which are harmful to the young and adult trees due to disease caused by transfer of bacteria (Liberibacter asiaticus) from the ACP to the young and adult citrus trees.

For clarification, it is pointed out that the term young trees is used for trees that are not yet producing and bearing fruits, and the term adult trees is used for trees old enough to produce and bear fruits.

The term chemical attractant and chemical repellent is used for substances that are acting by chemistry on the ACP, such as semiochemicals. The term non-chemical attractant and non-chemical repellent is used for substances that do not by chemical reaction. Examples are color agents, which act by a physical effect.

The method comprises, in the plantation,
selecting an ACP repellent among insect repellents that act repelling on ACP and selecting an ACP attractant among insect attractants that act attracting on ACP and selecting an ACP insecticide among insecticides that act insecticidal on ACP;
providing the ACP repellent on or at the adult trees but not on or at the young trees, and repelling the ACP from the adult trees by the ACP repellent;
covering each of the young trees individually with a net cover and protecting the young trees by the net covers against infestation by the ACP, each net cover comprising a mesh material that lets daylight pass through the mesh material to reach the young tree under the corresponding net cover, the mesh material comprising the ACP attractant and the ACP insecticide, and
attracting the ACP to the mesh material by the ACP attractant and killing the ACP by transfer of the ACP insecticide from the surface of the mesh material to the ACP upon contact between the ACP and the surface of the mesh material.

Examples of useful substances for the method of repelling and attracting the ACP are found among semiochemicals, such as allomones, kairomones, and pheromones.

For example, the ACP insecticide on the net cover is provided by surface treatment of the mesh material, in particular fibrous mesh material. However, advantageously, for long term efficacy, the mesh material is made from thermoplastic polymer material, advantageously polymer fibers, in which the ACP insecticide is melt-incorporated for gradual migration of the ACP insecticide from a bulk of the mesh material to the surface of the mesh material.

Typically, the mesh material is made of fibers that are mono-filaments or multi-filaments, which are knitted or woven into a mesh. However, the mesh material can also be a non-woven fibrous material.

In practical embodiments, the method comprises arranging the net cover around each of the young trees with a distance between the mesh material and the leaves of the respective young tree for preventing the ACP to reach the leaves of the young tree through the net cover, as the latter would result in the bacteria and the corresponding disease being transferred to the leaves.

Examples of attractants include alpha-phellandrene, beta-caryophyllene, methyl salicylate, and petitgrain oils mimicking the scents emitted by flushing shoots of citrus trees.

Various further attractants can be used, for example:
colors, such as lime-colored mesh material, for example colored with pantone 396;
UV reflecting materials, such as UV reflecting magnesium oxide (MgO);
LED UV light, for example in the wavelength range of 350-504 nm;

Examples of chemical insect repellents include guava allomones, (E)-β-caryophyllene, α-humulene, limonene, neem oil (azadirachtin), essential oils, for example lemongrass or citronella.

However, also other types of insect repellents can be used. For example, it has turned out that some red colors are repelling psyllids and may also be used. For example, the adult trees can potentially be colored red or provided with red elements for repelling the insects, and the young trees can be attracting ACP by a lime colored net.

In some embodiments, the repellent, for example a chemical repellent or a color agent, is sprayed on the adult trees.

Metallized polyethylene mulch on or at adult trees has also shown to be repellent, which is believed to be due to the flickering of light, confusing the insects.

Advantageously, non-chemical repellents and/or attractants are combined with chemical repellents and/or attractants.

Examples of useful insecticides include deltamethrin, beta-cyfluthrin, zeta-cypermethrin, and chlorantraniliprole. Optionally, a synergist, for example, piperonyl butoxide, PBO, is added to increase the insecticidal efficacy.

These insecticides also have a pesticidal effect against mealy bugs, white flies, army worms, scales, leaf miners, aphids, or diaprepes, fire ants, which are also damaging young citrus trees, which overall adds to the usefulness of these insecticides.

In order to minimize infestations by crawling insects, the stem or a portion of the stem of the young trees and/or the old trees is covered by an insecticidal sleeve, advantageously comprising one or more of the above-mentioned insecticides, potentially in combination with one or more synergists.

Polyolefins are among useful materials for the mesh material, for example polyester (polyethylene terephthalate), polyethylene, or polypropylene. Polyester fibers are typically made from multi-filaments, and polyethylene and polypropylene fibers typically from monofilaments.

Optionally, the mesh material is dimensioned with 400-600 mesh per square inch, optionally in the order of 500 mesh per square inch, which has an advantage over higher mesh numbers, for example 1250 mesh per square inch, in that it lets more light reach the young tree.

Rings or rods can be used to maintain a desired shape of the net cover around the young tree. An example is an umbrella-type support for the mesh material, which, optionally, is combines with horizontally oriented rings in order to maintain a distance between the mesh material and the tree.

The net cover is typically 1.5 to 3 m high, for example in the order of 8 feet tall (2.44 m).

Optionally, the net cover has a zip tie at the bottom or is bound with a band around the stem of the young tree.

By using combinations of a repellent, for example selected among allomones or other chemical repellents, on the adult trees and attractants, for example selected among kairomones or other chemical attractants, on the net covers for the young trees, the ACP can be guided away from the adult treed and towards the insecticides on the net cover and killed, thus, protecting adult as well as young trees.

### SHORT DESCRIPTION OF THE DRAWINGS

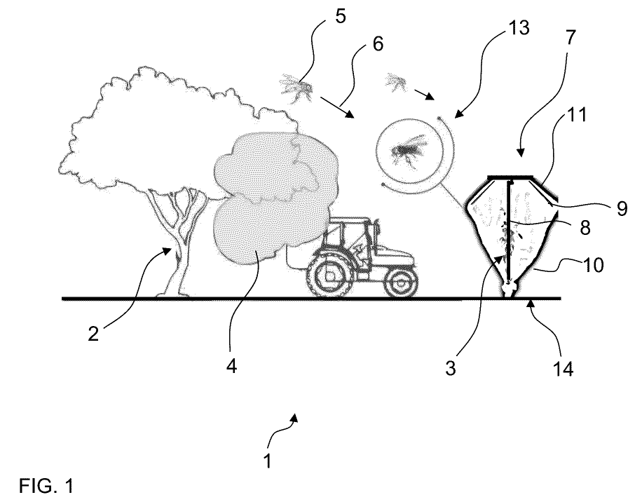

The invention will be explained in more detail with reference to the drawing, where FIG. 1 illustrates a principle of the push-pull effect on ACP.

### DETAILED DESCRIPTION/PREFERRED EMBODIMENT

FIG. 1 Illustrates the push-pull effect. In a plantation 1 of a citrus fruit farm, adult trees 2 and young trees 3 are provided, which are citrus trees. The aim is to protect the adult trees 2 as well as the young trees 3 against damage by ACP 5.

In order to achieve this, a repellent 4, for example chemical repellent, is provided on or at the adult trees 2, for example by spraying the repellent onto the leaves of the adult trees 2. The repellent 4 repels 6 the ACP 5 away from the adult trees 2. In this connection, it is advantageous that the repellent has a long-term repelling effect.

Once repelled, the ACP 5 will instead target the young trees 3. In order to protect the young trees 3, these are covered individually with a net cover 7. The net cover 7 comprises a mesh material 11 that lets daylight pass through the mesh material 11 to reach the young tree 3 under the net cover 7. For example, the net cover 7 is supported by a frame 9, optionally of an umbrella type structure supported by a support rod 8. Such umbrella-type structure expands the upper part, keeping a distance between the mesh material 11 and the young tree 3 so that the ACP 5 cannot reach the leaves of the young tree 3, which prevents transfer of the bacteria carried by the ACP. A lower part 10 of the net cover 7 is advantageously also made of a mesh material 11 and tapering towards the ground 14, for example bound around the stem of the young tree 3. Optionally, rings are employed in the lower part to make sure that a distance is kept between the leaves of the young tree and the net cover 7.

In order to minimize infestations by crawling insects, the stem or a portion of the stem of the young trees 3 and/or the old trees 2 is covered by an insecticidal sleeve, advantageously comprising one or more of the above-mentioned insecticides, potentially in combination with one or more synergists.

In order to enhance attraction of the ACP 5 toward the young trees 3, in particular towards the net cover 7, the net cover 7 contains an attractant, for example chemical attractant, that acts on the specific ACP 5. This attractant assists in protecting the adult trees.

As the ACP 5 are attracted towards the young trees 3, the ACP 5 will make contact with the net cover 7, in particular the mesh material 11. This mesh material 11 is provided with a transferable insecticide that is killing the ACP by transfer of the insecticide from the surface of the mesh material 11 to the ACP 5 upon contact between the ACP 5 and the surface of the mesh material 11, which is illustrated by the stylistic trap 13.

As a summary, the push-pull and killing effect is achieved by providing repellent to the adult trees 2 and an attractant, for example chemical attractant, and insecticide to the net cover 7 around the young trees 3.

For example, the mesh material 11 is made from thermoplastic polymer fibers. Advantageously, the insecticide is melt-incorporated for gradual migration of the insecticide from a bulk of the fibers to the surface of the fibers. A mesh material 11 that is applicable for this purpose is similar to mesh material used for mosquito nets. Polyolefins are among useful materials for the mesh material, for example polyester (polyethylene terephthalate), polyethylene, or polypropylene.

If the mesh material is loaded with insecticide to such concentration that it has an immediate knock-down effect on the ACP 5, the mesh size need not be smaller than the ACP 5 because the mere contact with the mesh material and the knock-down effect prevents the ACP from traversing the net. This allows the mesh fabric to me made more transmissive for UV light.

Optionally, the mesh material is dimensioned with 500 mesh per square inch, which has an advantage over higher mesh numbers, for example 1250 mesh per square inch, in that it lets more UV radiation reach the young tree.

Examples of useful substances for the method of repelling and attracting the ACP are found among semiochemicals, such as allomones, kairomones, and pheromones.

Examples of ACP repellents include guava allomones, (E)-β-caryophyllene, α-humulene, limonene, neem oil (azadirachtin), essential oils, for example lemongrass or citronella. A further alternatives is a combination of kaolin with thyme oil, which has proven more effective at repelling ACP. In particular, spraying or otherwise applying kaolin particle films, especially if dyed red, has been shown to significantly repel ACPs on non-IPC protected trees.

Examples of ACP attractants include alpha-phellandrene, beta-caryophyllene, methyl salicylate, or petitgrain oils mimicking the scents emitted by flushing shoots of citrus trees,

In order to increase the attraction of the ACP 5, the net cover 7 has a color that is attracting the ACP, for example with lime-colored mesh material, such as pantone 396. An alternative color is yellow.

Furthermore, the partial transparency of the mesh allows the ACP to see the fresh shoots of the young tree and the UV reflecting from these fresh shoots also attracts the psyllids. Examples of ACP insecticides include deltamethrin, beta-cyfluthrin, zeta-cypermethrin. A further alternatives is chlorantraniliprole. Optionally, a synergist, for example, PBO is added to increase the insecticidal efficacy.

Notice that the terms repellant, attractant, and insecticide also covers mix and combinations of repellants, mix and combinations of attractant, and mix and combinations of insecticides.

The term insecticide also covers combinations of insecticide and synergist, such as piperonyl butoxide (PBO) that increase the efficacy for knockdown and/or killing of the insecticide upon contact.

Another attractant that can be used is UV reflecting materials, such as UV reflecting magnesium oxide (MgO). Optionally, UV reflecting MgO (magnesium oxide) is added to the mesh material.

Alternatively, or in addition, an LED UV light can be used at the young protected trees, for example in the wavelength range of 350-504 nm.

The method as described herein is useful for protecting citrus trees, The citrus group of trees includes various types of fruit trees that produce citrus fruits, which are known for their vibrant flavors and high vitamin C content. The main types of citrus fruits and the trees are given in the following:
Oranges: Including varieties like Valencia, Navel, and Blood oranges. These trees are perhaps the most recognized citrus trees, widely cultivated for their sweet and juicy fruits.
Lemons: Common types include Eureka and Meyer lemons. Lemon trees are valued for their tart, flavor-enhancing fruit.
Limes: Key lime and Persian lime are popular varieties. Lime trees are smaller than most other citrus trees and can even be grown in pots.
Grapefruits: Including white, pink, and ruby red varieties. Grapefruit trees produce large, slightly bitter fruits that are popular in many breakfast dishes.
Mandarins: Including tangerines, clementines, and satsumas. Mandarin trees bear smaller, sweeter fruits that are easier to peel than oranges.
Pomelos: The largest type of citrus fruit, known for its mild and sweet flavor. Pomelo trees require a lot of space as they can grow rather large.
Kumquats: Unlike other citrus fruits, kumquats are eaten whole, including the peel. The trees are small and often used in ornamental landscaping.

1. A method of protecting a plurality of young and adult trees, which are citrus trees, in a tree plantation against disease caused by Asian citrus psyllids, ACP, infestation, wherein the young trees are trees that are not yet producing and bearing fruits, and the adult trees are trees old enough to produce and bear fruits, the method comprising, in the plantation,
selecting an ACP repellent among insect repellents that act repelling on ACP and selecting an ACP attractant among insect attractants that act attracting on ACP and selecting an ACP insecticide among insecticides that act insecticidal on ACP;
providing the ACP repellent on or at the adult trees but not on or at the young trees, and repelling the ACP from the adult trees by the ACP repellent;
covering each of the young trees individually with a net cover and protecting the young trees by the net covers against infestation by the ACP, each net cover comprising a mesh material that lets daylight pass through the mesh material to reach the young tree under the corresponding net cover, the mesh material comprising the ACP attractant and the ACP insecticide, and
attracting the ACP to the mesh material by the ACP attractant and killing the ACP by transfer of the ACP insecticide from the surface of the mesh material to the ACP upon contact between the ACP and the surface of the mesh material.

2. The method of claim 1, wherein the ACP repellent on the adult trees is sprayed on the adult trees but not the young trees.

3. The method according to claim 1, wherein the mesh material is made from thermoplastic polymer fibers in which the ACP insecticide is melt-incorporated for gradual migration of the ACP insecticide from a bulk of the fibers to the surface of the fibers.

4. The method of claim 1, wherein the ACP insecticide comprises deltamethrin, beta-cyfluthrin, zeta-cypermethrin or chlorantraniliprole or a combination of at least two of these.

5. The method of claim 4, wherein the ACP insecticide is provided in the mesh material combination with a synergist, for example PBO.

6. The method of claim 1, wherein the ACP attractant comprises alpha-phellandrene, beta-caryophyllene, methyl salicylate, petitgrain oils or a combination thereof.

7. The method of claim 1, wherein the ACP repellents comprises guava allomones, (E)-β-caryophyllene, α-humulene, limonene, neem oil, lemongrass oil, citronella or a combination thereof.

8. The method of claim 1, further comprising arranging the net cover around the young tree at a distance from the leaves of the respective young tree and preventing the ACP to reach the leaves of the young tree by the net cover.

9. The method of claim 1, wherein the mesh material is dimensioned with 400-600 mesh per square inch.

10. The method of claim 1, wherein the net cover is supported by a frame of an umbrella type structure supported by a support rod.

11. The method of claim 1, further comprising covering the stem or a portion of the stem of the young trees or the old trees or both by an insecticidal sleeve, and killing crawling insects by contact with the sleeve.
